(19) United States
(12) Patent Application Publication
(10) Pub. No.: US 2015/0185550 A1
(43) Pub. Date: Jul. 2, 2015

(54) COLOR FILTER SUBSTRATE AND LIQUID CRYSTAL DISPLAY PANEL

(71) Applicant: Shenzhen China Star Optoelectronics Tech, Co., Ltd, Shenzhen City, Guangdong (CN)

(72) Inventors: Bing Han, Shenzhen City (CN); Zuomin Liao, Shenzhen City (CN)

(21) Appl. No.: 14/347,611

(22) PCT Filed: Jan. 22, 2014
(86) PCT No.: PCT/CN2014/071158

§ 371 Date: Mar. 26, 2014

(30) Foreign Application Priority Data
Dec. 27, 2013 (CN) 201310733571.1

(51) Int. Cl. G02F 1/1335; G02B 5/20; G02F 1/1333; G02F 1/1368; G02F 1/1343

(52) U.S. Cl. CPC G02F 1/133514; G02F 1/1368; G02F 1/133512; G02F 1/134309; G02F 1/13439; G02F 1/133345; G02F 1/133305; G02B 5/201; G02F 2001/133357; G02F 2001/134345; G02F 2001/133368; G02F 2001/133302

(57) ABSTRACT

The present invention provides a color filter substrate and a liquid crystal display panel. The color filter substrate includes: a first transparent substrate (12), a black matrix (14) formed on the first transparent substrate (12), a sub-pixel layer (16) formed on the first transparent substrate (12) and corresponding to the black matrix (14), and a common electrode (18) formed on the black matrix (14), the first transparent substrate (12), and the sub-pixel layer (16). The common electrode (18) includes a plurality of holes (20) formed therein. The present invention uses a plurality of strip-like holes etched in a common electrode to correspond to a black matrix so as to increase the resistance in the color filter substrate, thereby increasing the difficult for coupling of the color filter substrate, improving the crosstalk phenomenon of a liquid crystal display, and enhancing the quality of displaying.

### BACKGROUND OF THE INVENTION

1. Field of the Invention

The present invention relates to the field of liquid crystal display technology, and in particular to a color filter substrate and a liquid crystal display panel.

2. The Related Arts

Liquid crystal displays have a variety of advantages, such as thin device body, low power consumption, and being free of radiation, and are thus widely used. Most of the liquid crystal displays that are currently available in the market are backlighting liquid crystal displays, which comprise a liquid crystal panel and a backlight module. The operation principle of the liquid crystal panel is that, with liquid crystal molecules interposed between two parallel glass substrates, a driving voltage is applied to the two glass substrates to control the rotation direction of the liquid crystal molecules in order to refract out light emitting from the backlight module for generating images. Since the liquid crystal panel does not emit light by itself, light must be provided from the backlight module in order to normally display images. Thus, the backlight module is one of the key components of a liquid crystal display. The backlight modules can be classified in two types, namely a side-edge backlight module and a direct backlight module, according to the position where light gets incident. The direct backlight module comprises a light source, such as a cold cathode fluorescent lamp (CCFL) or a light-emitting diode (LED), which is arranged at the backside of the liquid crystal panel to form a planar light source directly supplied to the liquid crystal panel. The side-edge backlight module comprises an LED light bar, serving as a backlight source, which is arranged at an edge of a backplane to be located rearward of one side of the liquid crystal panel. The LED light bar emits light that enters a light guide plate (LGP) through a light incident face at one side of the light guide plate and is projected out of a light emergence face of the light guide plate, after being reflected and diffused, to form a planar light source for the liquid crystal display panel.

The liquid crystal displays are a passive display device. To provide an effect of color displaying, color filters must be provided for the function of conversion white light into color light beams of three primary colors of red, green, and blue in order to achieve an effect of displaying images of various colors. Referring to FIG. 1, which is a schematic view showing the structure of a conventional color filter substrate, the color filter substrate comprises: a glass substrate 102, a black matrix area 104, a sub-pixel layer 106, a planarization layer 108, and a common electrode 109. The sub-pixel layer 106 is made up of three light-filtering pixels including a red sub-pixel 202, a green sub-pixel 204, and a blue sub-pixel 206 that are formed of organic color coatings. The three light-filtering pixels are repeatedly and regularly arranged to respectively enable passages of three primary color lights of red, green, and blue and blocking of lights of other wavelengths from transmission. The black matrix area 104 is arranged among the three light-filtering pixels with a function of blocking the lights passing through the three light-filtering pixels and preventing light leaking and also preventing mixing of colorant materials.

In a TFT-LCD panel, the common electrode of the color filter substrate and a pixel electrode of an array substrate collectively control brightening and darkening of a pixel. However, the potential of the common electrode of the color filter substrate is susceptible to the influence of high/low levels, leading to a phenomenon of crosstalk. Referring to FIG. 2, taking a trigate product as an example, when a hand touches a pattern on a liquid crystal display panel, the common electrode of the color filter substrate is coupled with high/low voltage level, inducing crosstalk 300. Referring to FIG. 3, the electrical resistance between points A and B of FIG. 2 is R1. There is generally no solution for such a problem unless the cell gap is increased to reduce the coupling capacitance. However, the cell gap is generally fixed.

### SUMMARY OF THE INVENTION

An object of the present invention is to provide a color filter substrate, which comprises a plurality of strip-like holes etched in a common electrode to correspond to a black matrix in order to increase the electrical resistance of the color filter substrate thereby raising the difficult of coupling of the color filter substrate, improving the crosstalk phenomenon of a liquid crystal display, and enhancing quality of displaying.

Another object of the present invention is to provide a liquid crystal display panel, which comprises a plurality of strip-like holes etched in a common electrode of a color filter substrate to correspond to a black matrix in order to increase the electrical resistance of the color filter substrate thereby raising the difficult of coupling of the color filter substrate, improving the crosstalk phenomenon of a liquid crystal display, and enhancing quality of displaying.

To achieve the above objects, the present invention provides a color filter substrate, comprising: a first transparent substrate, a black matrix formed on the first transparent substrate, a sub-pixel layer formed on the first transparent substrate and corresponding to the black matrix, and a common electrode formed on the black matrix, the first transparent substrate, and the sub-pixel layer. The common electrode comprises a plurality of holes formed therein.

Each of the holes has a shape of a strip-like form and the plurality of holes is arranged parallel to each other.

The plurality of holes is arranged to correspond to the black matrix.

The color filter substrate further comprises: a planarization layer formed on the black matrix and the sub-pixel layer. The common electrode is formed on the planarization layer.

The common electrode comprises an indium tin oxide pattern and the first transparent substrate is one of a plastic substrate and a glass substrate. The sub-pixel layer comprises: a red sub-pixel, a green sub-pixel, and a blue sub-pixel.

The present invention also provides a color filter substrate, which comprises: a first transparent substrate, a black matrix formed on the first transparent substrate, a sub-pixel layer formed on the first transparent substrate and corresponding to the black matrix, and a common electrode formed on the black matrix, the first transparent substrate, and the sub-pixel layer, the common electrode comprising a plurality of holes formed therein;

wherein each of the holes has a shape of a strip-like form and the plurality of holes is arranged parallel to each other.

The plurality of holes is arranged to correspond to the black matrix.

The color filter substrate further comprises: a planarization layer formed on the black matrix and the sub-pixel layer. The common electrode is formed on the planarization layer.

The common electrode comprises an indium tin oxide pattern and the first transparent substrate is one of a plastic substrate and a glass substrate. The sub-pixel layer comprises: a red sub-pixel, a green sub-pixel, and a blue sub-pixel.

The present invention further provides a liquid crystal display panel, which comprises: an array substrate, a color filter substrate laminated to the array substrate, and liquid crystal material hermetically sealed between the substrates. The color filter substrate comprises: a first transparent substrate, a black matrix formed on the first transparent substrate, a sub-pixel layer formed on the first transparent substrate and corresponding to the black matrix, and a common electrode formed on the black matrix, the first transparent substrate, and the sub-pixel layer. The common electrode comprises a plurality of holes formed therein.

The plurality of holes is arranged to correspond to the black matrix. Each of the holes has a shape of a strip-like form. The plurality of holes is arranged parallel to each other.

The array substrate comprises: a second transparent substrate, a first metal layer formed on the second transparent substrate, an insulation layer formed on the first metal layer and the second transparent substrate, a semiconductor layer formed on the insulation layer, a heavily doped n+ semiconductor layer formed on the semiconductor layer, a second metal layer formed on the semiconductor layer, the heavily doped n+ semiconductor layer, and the insulation layer, a protective layer formed on the second metal layer and the insulation layer, and a pixel electrode formed on the protective layer. The second metal layer is used to form a source terminal, a drain terminal, and a data line. The plurality of holes is arranged to correspond to the black matrix and the data line. The second transparent substrate is one of a plastic substrate and a glass substrate.

The liquid crystal display panel further comprises: a planarization layer formed on the black matrix and the sub-pixel layer. The common electrode is formed on the planarization layer.

The common electrode comprises an indium tin oxide pattern and the first transparent substrate is one of a plastic substrate and a glass substrate. The sub-pixel layer comprises: a red sub-pixel, a green sub-pixel, and a blue sub-pixel.

The efficacy of the present invention is that the present invention provides a color filter substrate, which comprises a plurality of strip-like holes etched in a common electrode to correspond to a black matrix so as to increase the resistance in the color filter substrate, thereby increasing the difficult for coupling of the color filter substrate, improving the crosstalk phenomenon of a liquid crystal display, and enhancing the quality of displaying. The present invention also provides a liquid crystal display panel, which comprises a plurality of strip-like holes etched in a common electrode of a color filter substrate to correspond to a black matrix and a data line of an array substrate so as to increase the resistance in the color filter substrate, thereby increasing the difficult for coupling of the color filter substrate, improving the crosstalk phenomenon of a liquid crystal display, and enhancing the quality of displaying.

For better understanding of the features and technical contents of the present invention, reference will be made to the following detailed description of the present invention and the attached drawings. However, the drawings are provided for the purposes of reference and illustration and are not intended to impose limitations to the present invention.

### BRIEF DESCRIPTION OF THE DRAWINGS

The technical solution, as well as other beneficial advantages, of the present invention will be apparent from the following detailed description of embodiments of the present invention, with reference to the attached drawing. In the drawing:

FIG. 1 is a schematic view showing the structure of a conventional color filter substrate;

FIG. 2 is a schematic view illustrating a crosstalk phenomenon occurring in a conventional liquid crystal display;

FIG. 3 is an equivalent circuit diagram of the potentials at two sites A, B of FIG. 2;

FIG. 4 is a schematic view showing the structure of a color filter substrate according to the present invention;

FIG. 5 is a top plan view showing a common electrode of FIG. 4;

FIG. 6 is an equivalent circuit diagram of potential of the color filter substrate according to the present invention; and

FIG. 7 is a schematic view showing the structure of a liquid crystal display panel according to the present invention.

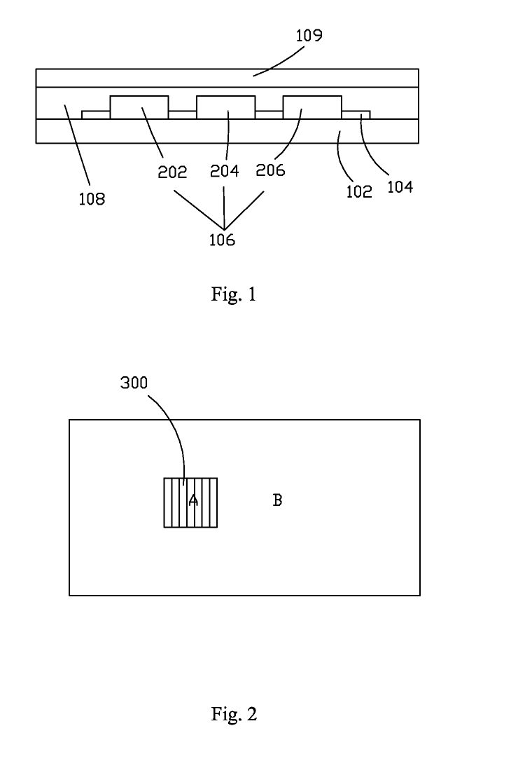

### DETAILED DESCRIPTION OF THE PREFERRED EMBODIMENTS

To further expound the technical solution adopted in the present invention and the advantages thereof, a detailed description is given to preferred embodiments of the present invention and the attached drawings.

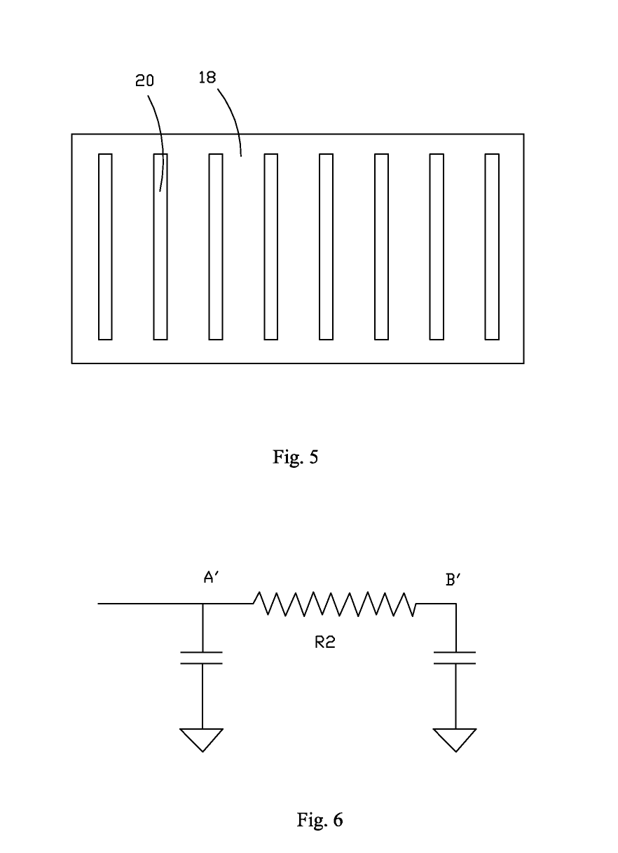

Referring to FIG. 4, the present invention provides a color filter substrate 10, which comprises: a first transparent substrate 12, a black matrix 14 formed on the first transparent substrate 12, a sub-pixel layer 16 formed on the first transparent substrate 12 and corresponding to the black matrix 14, and a common electrode 18 formed on the black matrix 14, the first transparent substrate 12, and the sub-pixel layer 16. The common electrode 18 comprises a plurality of holes 20 formed therein.

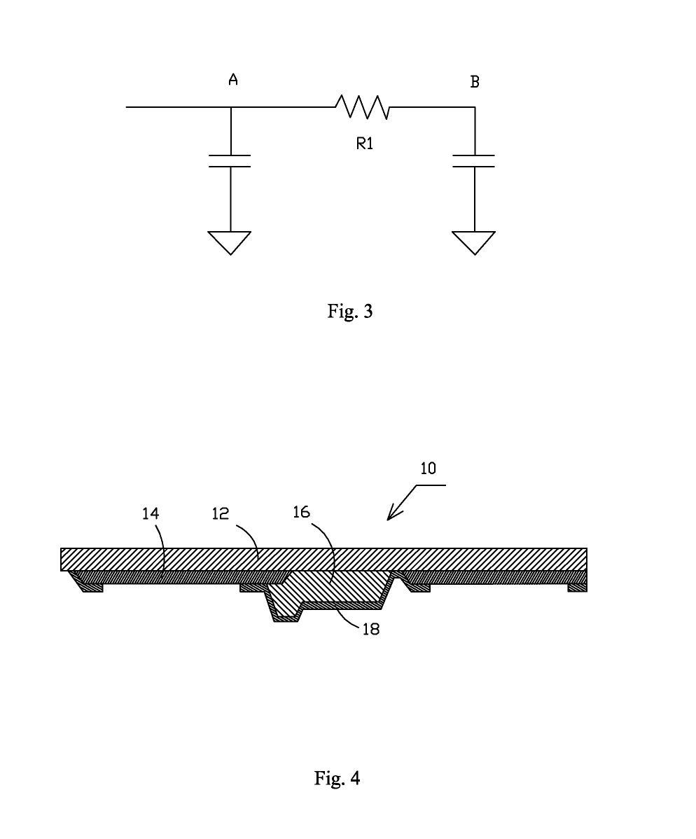

In the instant embodiment, the plurality of holes 20 is arranged to correspond to the black matrix 14. Each of the holes 20 has a shape of a strip-like form and the plurality of holes 20 is arranged parallel to each other, as shown in FIG. 5. The formation of the strip-like holes 20 in the common electrode 18 increases the resistance in the color filter substrate 10. Further referring to FIG. 6, with additional reference to FIG. 3, FIG. 6 shows an equivalent circuit diagram of potential of the color filter substrate 10 according to the present invention. In the drawing, A′ is equivalent to point A of FIG. 3 and B′ is equivalent point B of FIG. 3. The resistance between A′, B′ is R2. Due to the addition of the plurality of strip-like holes 20, the resistance R2 between A′, B′ is greater than the resistance R1 between A, B of FIG. 3, namely R2>R1. By etching the common electrode 18 at portion corresponding to the black matrix 14 to form a plurality of strip-like holes 20, the present invention significantly increases the resistance in the color filter substrate 10, thereby increasing the difficult for coupling of the color filter substrate 10, improving the crosstalk phenomenon of a liquid crystal display, and enhancing the quality of displaying.

The color filter substrate 10 further comprises: a planarization layer formed on the black matrix 14 and the sub-pixel layer 16 (where the drawings not show the planarization layer for purposes of easy reading). The common electrode 18 is formed on the planarization layer.

The common electrode 18 comprises an indium tin oxide pattern, which is formed through processes of exposure, development, and etching. The first transparent substrate 12 can be a plastic substrate or a glass substrate. The sub-pixel layer 16 comprises: a red sub-pixel, a green sub-pixel, and a blue sub-pixel, whereby by guiding light white to pass the three sub-pixels, lights of three primary colors of red, green, and blue can be formed to achieve color displaying.

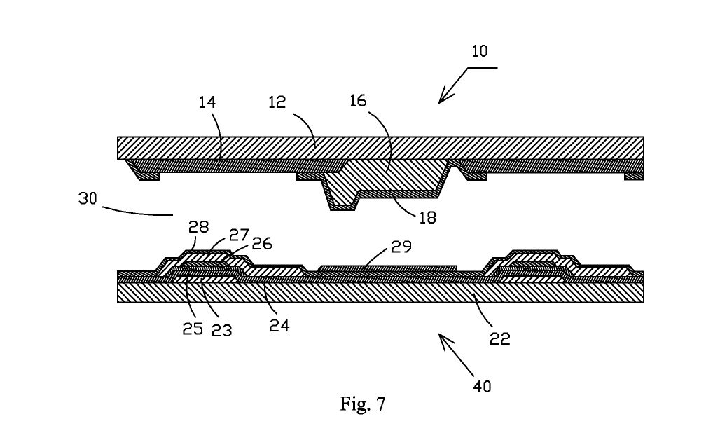

Referring to FIGS. 5-7, the present invention further provides a liquid crystal display panel, which comprises: an array substrate 40, a color filter substrate 10 laminated to the array substrate 40, and liquid crystal material 30 hermetically sealed between the substrates. The color filter substrate 10 comprises: a first transparent substrate 12, a black matrix 14 formed on the first transparent substrate 12, a sub-pixel layer 16 formed on the first transparent substrate 12 and corresponding to the black matrix 14, and a common electrode 18 formed on the black matrix 14, the first transparent substrate 12, and the sub-pixel layer 16. The common electrode 18 comprises a plurality of holes 20 formed therein.

The array substrate 40 comprises: a second transparent substrate 22, a first metal layer 23 formed on the second transparent substrate 22, an insulation layer 24 formed on the first metal layer 23 and the second transparent substrate 22, a semiconductor layer 25 formed on the insulation layer 24, a heavily doped n+ semiconductor layer 26 formed on the semiconductor layer 25, a second metal layer 27 formed on the semiconductor layer 25, the heavily doped n+ semiconductor layer 26, and the insulation layer 24, a protective layer 28 formed on the second metal layer 27 and the insulation layer 24, and a pixel electrode 29 formed on the protective layer 28. The first metal layer 23 is used to form a gate terminal and a gate line. The second metal layer 27 is used to form a source terminal, a drain terminal, and a data line. The second transparent substrate 22 can be a plastic substrate or a glass substrate. In the instant embodiment, the plurality of holes 20 is arranged to correspond to the black matrix 14 and the data line. Each of the holes 20 has a shape of a strip-like form and the plurality of holes 20 is arranged parallel to each other, as shown in FIG. 5.

The formation of the strip-like holes 20 in the common electrode 18 increases the resistance in the color filter substrate 10. Further referring to FIG. 6, with additional reference to FIG. 3, FIG. 6 shows an equivalent circuit diagram of potential of the color filter substrate 10 according to the present invention. In the drawing, A′ is equivalent to point A of FIG. 3 and B′ is equivalent point B of FIG. 3. The resistance between A′, B′ is R2. Due to the addition of the plurality of strip-like holes 20, the resistance R2 between A′, B′ is greater than the resistance R1 between A, B of FIG. 3, namely R2>R1. By etching the common electrode 18 at portion corresponding to the black matrix 14 to form a plurality of strip-like holes 20, the present invention significantly increases the resistance in the color filter substrate 10, thereby increasing the difficult for coupling of the color filter substrate 10, improving the crosstalk phenomenon of a liquid crystal display, and enhancing the quality of displaying.

The color filter substrate 10 further comprises: a planarization layer formed on the black matrix 14 and the sub-pixel layer 16 (where the drawings not show the planarization layer for purposes of easy reading). The common electrode 18 is formed on the planarization layer.

The common electrode 18 comprises an indium tin oxide pattern, which is formed through processes of exposure, development, and etching. The first transparent substrate 12 can be a plastic substrate or a glass substrate. The sub-pixel layer 16 comprises: a red sub-pixel, a green sub-pixel, and a blue sub-pixel, whereby by guiding light white to pass the three sub-pixels, lights of three primary colors of red, green, and blue can be formed to achieve color displaying.

In summary, the present invention provides a color filter substrate, which comprises a plurality of strip-like holes etched in a common electrode to correspond to a black matrix so as to increase the resistance in the color filter substrate, thereby increasing the difficult for coupling of the color filter substrate, improving the crosstalk phenomenon of a liquid crystal display, and enhancing the quality of displaying. The present invention also provides a liquid crystal display panel, which comprises a plurality of strip-like holes etched in a common electrode of a color filter substrate to correspond to a black matrix and a data line of an array substrate so as to increase the resistance in the color filter substrate, thereby increasing the difficult for coupling of the color filter substrate, improving the crosstalk phenomenon of a liquid crystal display, and enhancing the quality of displaying.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A color filter substrate, comprising: a first transparent substrate, a black matrix formed on the first transparent substrate, a sub-pixel layer formed on the first transparent substrate and corresponding to the black matrix, and a common electrode formed on the black matrix, the first transparent substrate, and the sub-pixel layer, the common electrode comprising a plurality of holes formed therein.

2. The color filter substrate as claimed in claim 1, wherein each of the holes has a shape of a strip-like form and the plurality of holes is arranged parallel to each other.

3. The color filter substrate as claimed in claim 1, wherein the plurality of holes is arranged to correspond to the black matrix.

4. The color filter substrate as claimed in claim 3 further comprising: a planarization layer formed on the black matrix and the sub-pixel layer, the common electrode being formed on the planarization layer.

5. The color filter substrate as claimed in claim 1, wherein the common electrode comprises an indium tin oxide pattern and the first transparent substrate is one of a plastic substrate and a glass substrate, the sub-pixel layer comprising: a red sub-pixel, a green sub-pixel, and a blue sub-pixel.

6. A color filter substrate, comprising: a first transparent substrate, a black matrix formed on the first transparent substrate, a sub-pixel layer formed on the first transparent substrate and corresponding to the black matrix, and a common electrode formed on the black matrix, the first transparent substrate, and the sub-pixel layer, the common electrode comprising a plurality of holes formed therein;
wherein each of the holes has a shape of a strip-like form and the plurality of holes is arranged parallel to each other.

7. The color filter substrate as claimed in claim 6, wherein the plurality of holes is arranged to correspond to the black matrix.

8. The color filter substrate as claimed in claim 7 further comprising: a planarization layer formed on the black matrix and the sub-pixel layer, the common electrode being formed on the planarization layer.

9. The color filter substrate as claimed in claim 6, wherein the common electrode comprises an indium tin oxide pattern and the first transparent substrate is one of a plastic substrate and a glass substrate, the sub-pixel layer comprising: a red sub-pixel, a green sub-pixel, and a blue sub-pixel.

10. A liquid crystal display panel, comprising: an array substrate, a color filter substrate laminated to the array substrate, and liquid crystal material hermetically sealed between the substrates, the color filter substrate comprising: a first transparent substrate, a black matrix formed on the first transparent substrate, a sub-pixel layer formed on the first transparent substrate and corresponding to the black matrix, and a common electrode formed on the black matrix, the first transparent substrate, and the sub-pixel layer, the common electrode comprising a plurality of holes formed therein.

11. The liquid crystal display panel as claimed in claim 10, wherein the plurality of holes is arranged to correspond to the black matrix, each of the holes having a shape of a strip-like form, the plurality of holes being arranged parallel to each other.

12. The liquid crystal display panel as claimed in claim 10, wherein the array substrate comprises: a second transparent substrate, a first metal layer formed on the second transparent substrate, an insulation layer formed on the first metal layer and the second transparent substrate, a semiconductor layer formed on the insulation layer, a heavily doped n+ semiconductor layer formed on the semiconductor layer, a second metal layer formed on the semiconductor layer, the heavily doped n+ semiconductor layer, and the insulation layer, a protective layer formed on the second metal layer and the insulation layer, and a pixel electrode formed on the protective layer, the second metal layer being used to form a source terminal, a drain terminal, and a data line, the plurality of holes being arranged to correspond to the black matrix and the data line, the second transparent substrate being one of a plastic substrate and a glass substrate.

13. The liquid crystal display panel as claimed in claim 12 further comprising: a planarization layer formed on the black matrix and the sub-pixel layer, the common electrode being formed on the planarization layer.

14. The liquid crystal display panel as claimed in claim 10, wherein the common electrode comprises an indium tin oxide pattern and the first transparent substrate is one of a plastic substrate and a glass substrate, the sub-pixel layer comprising: a red sub-pixel, a green sub-pixel, and a blue sub-pixel.
